(19) United States
(12) Patent Application Publication
(10) Pub. No.: US 2019/0111954 A1
(43) Pub. Date: Apr. 18, 2019

(54) STORAGE CONTAINER WITH RAISABLE CADDY AND METHOD

(71) Applicant: Greg Grotton, Union, ME (US)

(72) Inventor: Greg Grotton, Union, ME (US)

(21) Appl. No.: 16/162,375

(22) Filed: Oct. 16, 2018

Related U.S. Application Data
(60) Provisional application No. 62/572,749, filed on Oct. 16, 2017.

(51) Int. Cl. B62B 1/26; B25H 1/12; B62B 1/00

(52) U.S. Cl. CPC B62B 1/26; B62B 1/008; B25H 1/12

(57) ABSTRACT

A container and caddy system is disclosed herein. The container and caddy system includes a storage container and a caddy for supporting and transporting the storage container. The storage container has a receptacle, a lid, and one or more hinges. The hinges connect the lid to the receptacle, enabling easy access to the interior of the receptacle. The caddy has a frame dimensioned to accept the storage container, four wheels able to roll the caddy along the ground, and two or more lift members. The lift members are divided into first and second lift member assemblies. These mechanically connect the wheels to the frame and are connected to each other by a hinge pin which causes the first and second lift member assemblies to move in a scissoring action to raise or lower the frame relative to the wheels.

### CROSS-REFERENCE TO RELATED APPLICATION(S)

The present application is related to and claims priority to U.S. Provisional Patent Application No. 62/572,749 filed Oct. 16, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of containers of existing art and more specifically relates to vehicle-adaptable tool boxes.

### RELATED ART

Many individuals, such as carpenters, construction workers, repair personnel, etc. use the rear seat of their vehicle to transport items. These untethered objects can be thrown around in the backseat and become flying projectiles in the event of an accident, potentially causing injuries. Individuals that transport items for work may waste significant time returning back to the vehicle to retrieve items they need on their work site. This is not only time consuming and inconvenient but can also lead to injuries when carrying heavy or awkward items repeatedly. An effective alternative is needed.

U.S. Pat. No. 6,935,641 to Richard Duk Wong Hahn relates to a portable combination toolbox, workbench, and dispensing crib. The described portable combination toolbox, workbench, and dispensing crib includes a portable toolbox having a top, bottom, front and rear panels forming a box structure with opposing sides tilted off-vertical so as to converge upwardly. A plurality of hinged drawers and fixed bins are arranged on each side of the toolbox. The rear panel terminates at a pair of supporting feet for resting the apparatus on a supporting surface and a pair of wheels for moving the toolbox. By lifting the toolbox from its forward end, the toolbox moves from resting on its rear legs, to resting on its rear wheels. The top panel provides an upwardly facing work surface with a pair of hand holes separated by a hand grip for carrying the apparatus. A forward and a rearward sliding retractable work surface extender frames are positionable between a retracted position, secured within the box structure and an extended position directed outwardly from the box structure for resting a workpiece.

### SUMMARY OF THE INVENTION

In view of the foregoing disadvantages inherent in the known vehicle-adaptable tool box art, the present disclosure provides a novel storage container with a raisable caddy and method. The general purpose of the present disclosure, which will be described subsequently in greater detail, is to provide a storage container with a raisable caddy and method.

This document discloses a container and caddy system. The container and caddy system includes a storage container and a caddy for supporting and transporting the storage container. The storage container has a receptacle, a lid, and one or more hinges. The hinges connect the lid to the receptacle, enabling easy access to the interior of the receptacle. The caddy has a frame dimensioned to accept and support the storage container, four wheels able to roll the caddy along the ground, and two or more lift members. The lift members are divided into first and second lift member assemblies. These mechanically connect the wheels to the frame and are connected to each other by a hinge pin that causes the first and second lift member assemblies to move in a scissoring relation to raise or lower the frame relative to the wheels.

According to another embodiment, this document also discloses a method of using a container and caddy system. The method of using a container and caddy system includes providing a container and caddy system, pushing the caddy towards the storage container, raising or lowering the container frame until the container frame is level with the storage container, sliding the storage container onto the container frame, lowering or raising the container frame to a desired height for transport, conveying the caddy to a destination, and optionally, opening the container lid of the storage container to access contents stored within the storage container.

For purposes of summarizing the invention, certain aspects, advantages, and novel features of the invention have been described. Not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a storage container with raisable caddy and method, constructed and operative according to the teachings of the present disclosure.

FIG. 1 is a side perspective view of the container and caddy system during an ‘in-use’ condition, according to an embodiment of the disclosure.

FIG. 2 is a top perspective view of the container frame of the container and caddy system of FIG. 1 or another embodiment of the present disclosure.

FIG. 3 is a perspective view of the storage container of the container and caddy system of FIG. 1 or another embodiment of the present disclosure.

FIG. 4 is a side perspective view of the container and caddy system of FIG. 1 or another embodiment of the present disclosure.

FIG. 5 is a flow diagram illustrating a method of use for using a container and caddy system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a vehicle-adaptable tool box and more particularly to a storage container with raisable caddy and method as used to improve the maneuverability and flexibility of a storage solution.

Generally, the storage container with raisable caddy provides a container that may serve as a combination rolling work station and tool bench and may be removed from a storage location within a vehicle and used portably at a worksite. The container may deploy by being rolled out from a rear vehicle seat or other convenient storage location. However, the container may be stored in other locations, as well. The container may include modular table attachments to extend the workspace of the system. An interior cavity is useful as storage space for tools, files, and other equipment for use on a work site. The storage container with raisable caddy eliminates the need for users to go back and forth between a vehicle and their work site, as is commonly necessary with fixed vehicular storage systems. This is accomplished by making the container and an accompanying caddy modular, specifically structured to accept the container and conveniently transport it from a storage location to a jobsite or other destination.

The container of the storage container with raisable caddy is designed to be slid out of a vehicle onto the caddy, which may be conveniently positioned and angled to make deployment of the container simple. The caddy includes a scissor-lifting mechanism with a frame and surface for supporting the container attached to the top. It may have wheels allow movement from place to place. A manually adjustable articulating mechanism may allow a user to change the angle of the top surface, making it easier to slide the container onto the caddy. Side rails on the caddy may prevent the container from slipping off the caddy during transport. The caddy may be constructed of a lightweight aluminum. In some embodiments the container may include a second cavity, possibly taking the form of a drawer, comprising a storage area for files, tools, and more. The exact specifications may vary.

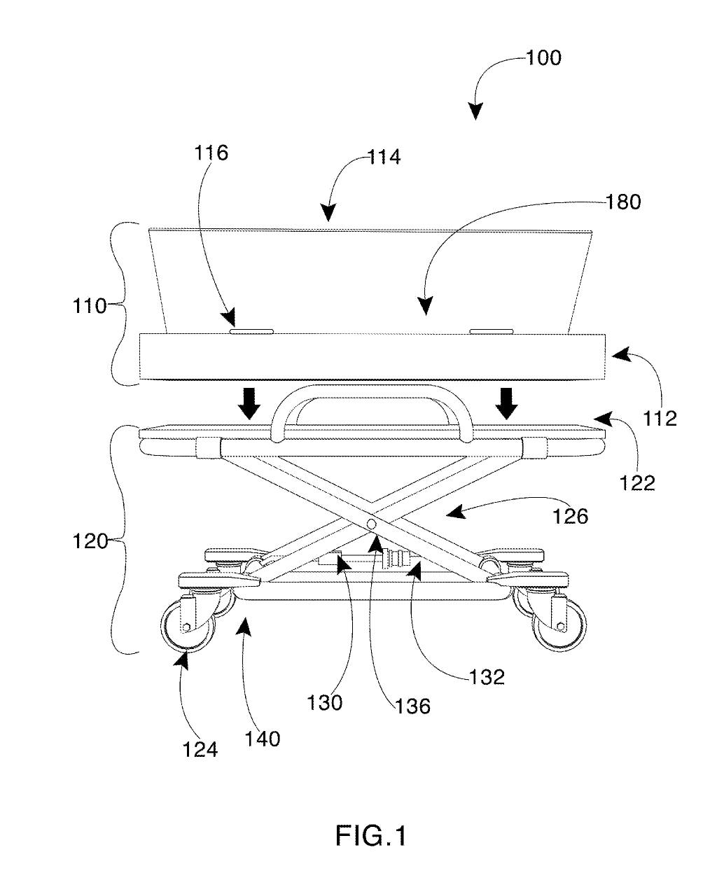

Referring now more specifically to the drawings by numerals of reference, there is shown in FIGS. 1-4, various views of a container and caddy system 100.

FIG. 1 shows a container and caddy system during an ‘in-use’ condition according to an embodiment of the present disclosure. Here, container and caddy system 100 may provide and maneuver a convenient storage container. As illustrated, container and caddy system 100 may include storage container 110 and caddy 120. Caddy 120 may be structured and arranged to support storage container 110 above the ground for accessibility and transport. Storage container 110 may be adapted to store object and may have structural features making it advantageous for storage within a vehicle, particularly an automobile. Storage container 110 may itself include storage receptacle 112, storage lid 114, and at least one hinge 116. At least one hinge 116 may pivotably connect storage lid 114 to storage receptacle 112, such that when storage lid 114 is in a closed condition, storage lid 114 and storage receptacle 112 in combination enclose interior space 180. When storage lid 114 is moved to an open condition by rotating at least one hinge 116, a user may access the interior space 180 of storage container 110 to store or retrieve items. In a preferred embodiment, storage lid 114 and storage receptacle 112 in combination enclose interior space 180, such that interior space 180 is substantially prismatic, rectangular, or square.

Caddy 120 may itself include container frame 122, four wheels 124, at least two lift members 126, and one or more of hinge pin 136. Container frame 122 may be able to accept and support storage container 110 and may be structured and arranged to prevent lateral displacement of storage container 110 from caddy 120, thereby safely supporting and retaining storage container 110. In this way, storage container 110 may most conveniently be removed from caddy 120 by sliding storage container 110 onto container frame 122 lengthwise. Each of at least two lift members 126 may correspond to one or more of 2, 3, or 4 wheels 124. Each of at least two lift members 126 may mechanically connect the corresponding wheels 124 to container frame 122. At least two lift members 126 may themselves be divided into first lift-member assembly 130 and second lift-member assembly 132. In some embodiments, first lift-member assembly 130 and second lift-member assembly 132 may each include multiple integral appendages working together to support container frame 122 above wheels 124. For example, in one embodiment each of first lift-member assembly 130 and second lift-member assembly 132 may comprise a substantially rectangular, unitary frame constructed of tubular stock having rounded corners. One or more hinge pins 136 may operatively and mechanically couple first lift-member assembly 130 to second lift-member assembly 132 in such a way that first lift-member assembly 130 and second lift-member assembly 132 can pivot relative to each other in a scissoring fashion. Preferably, one or more hinge pins 136 centrally bisect each of first lift-member assembly 130 and second lift-member assembly 132, such that hinge pin 136 sits near a halfway location along a length of each of first lift-member assembly 130 and second lift-member assembly 132. While hinge pin 136 may not be exactly central to each of first lift-member assembly 130 and second lift-member assembly 132, hinge pin 136 is positioned in such a way that there is substantial length available to each of first lift-member assembly 130 and second lift-member assembly 132 on either side of hinge pin 136. In this way sufficient leverage may be applied towards rotating first lift-member assembly 130 and second lift-member assembly 132 on either side while also maintaining a balanced assembly.

Caddy 120 may also include wheel frame 140 mechanically connecting 2, 3, or 4 wheels 124 to each other. Wheel frame 140 may be substantially rectangular. Wheel frame 140 may be constructed of multiple fastened components or may be of a unitary or monolithic construction. Wheel frame 140 may have rounded or chamfered corners and may include additional structural features. Preferably, first lift-member assembly 130 and second lift-member assembly 132 connect directly to wheel frame 140, and may further include pins, hinges, or other pivoting devices for enabling first lift-member assembly 130 and second lift-member assembly 132 to rotate relative to wheel frame 140. In some embodiments, wheel frame 140 may include tracks or slides for first lift-member assembly 130 and second lift-member assembly 132 to translate relative to wheel frame 140. However, in a preferred embodiment first lift-member assembly 130 and second lift-member assembly 132 merely pivot relative to wheel frame 140. In some embodiments, first lift-member assembly 130 and second lift-member assembly 132 translate relative to wheel frame 140, just as first lift-member assembly 130 and second lift-member assembly 132 to translate relative to container frame 122.

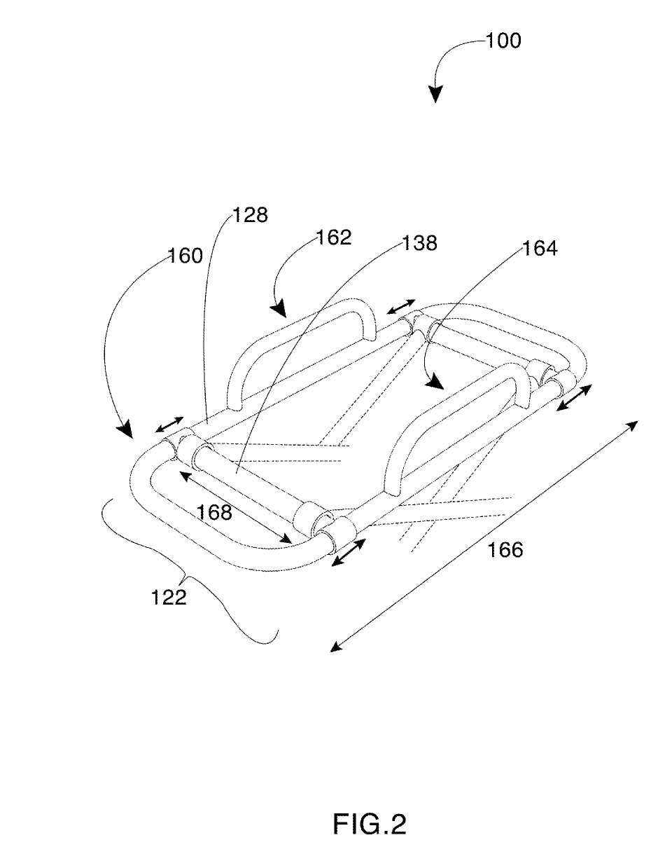

FIG. 2 shows container and caddy system 100 of FIG. 1, according to an embodiment of the present disclosure. Container frame 122 may include at least one slide 128 and each of at least two lift members 126 (FIG. 1) and may further comprise at least one yoke 138, wherein each of the yokes 138 are dimensioned to circumscribe and slide along at least one slide 128, thereby enabling first lift-member assembly 130 (FIG. 1) to pivot relative to second lift-member assembly 132 (FIG. 1), as the distal ends of each are not constrained. Accordingly, when first lift-member assembly 130 (FIG. 1) and second lift-member assembly 132 (FIG. 1) together pivot, container frame 122 is either raised or lowered. Preferably, each of first lift-member assembly 130 (FIG. 1) and second lift-member assembly 132 (FIG. 1) include two of yoke 138 to engage both left and right sides of container frame 122. At least one slide 128 may in a preferred embodiment include one left-side unit and one down unit as illustrated. Each of these may be sufficiently long to act as a slide for the yokes 138 of both first lift-member assembly 130 (FIG. 1) and second lift-member assembly 132 (FIG. 1) at opposite ends of container frame 122. These left and right sides of container frame 122 may represent the longer length of container frame 122 when container frame 122 is substantially rectangular. Container frame 122 may have chamfered or rounded corners and may include additional structural features other than described.

Container frame 122 may further include rectangular chassis 160, left guide rail 162, and right guide rail 164. Rectangular chassis 160 may have chassis length 166 and chassis width 168, each being sufficiently large to support storage container 110 (FIG. 1), left guide rail 162 mirroring right guide rail 164 across rectangular chassis 160, left guide rail 162 and right guide rail 164 each being affixed rigidly and perpendicularly to rectangular chassis 160 such that left guide rail 162 and right guide rail 164 each stand upright, left guide rail 162 and right guide rail 164 being spaced wide enough to surround storage container 110 (FIG. 1) on opposite sides of storage container 110 (FIG. 1) when storage container 110 (FIG. 1) is placed upon rectangular chassis 160. In a preferred embodiment, left guide rail 162 and right guide rail 164 are structured and arranged such that they are integral to and function as at least one slide 128. As illustrated, left guide rail 162 and right guide rail 164 may be constructed of cylindrical or tubular members. In some embodiments, all of chassis 160 is tubular.

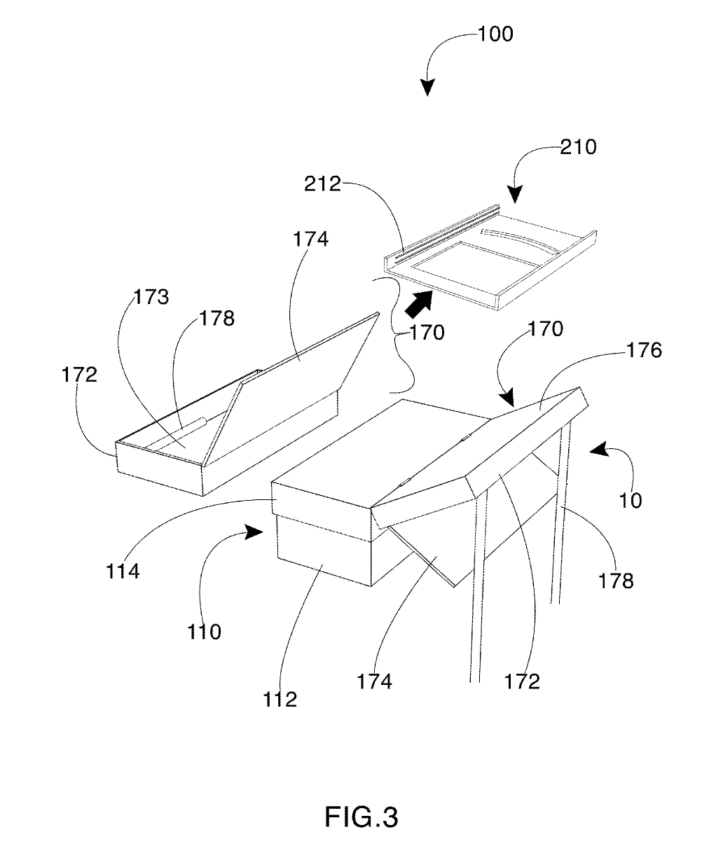

FIG. 3 is a perspective view of the storage container of the container and caddy system of FIG. 1, according to an embodiment of the present disclosure. Storage container 110 may further include leg chassis 170. Leg chassis 170 may be hingedly attached to storage receptacle 112 of the container and alternatively to storage lid 114. Leg chassis 170 may itself include leg receptacle 172, leg chassis lid 174, bottom surface 176, and at least one deployable table leg 178. Rectangular leg receptacle 172 may define leg chassis interior 173. Preferably, leg chassis interior 173 is substantially prismatic. Leg chassis lid 174 may be hingedly attached to leg receptacle 172. Preferably, leg chassis lid is substantially rectangular and may represent on, side-bounding leg chassis interior 173 for some embodiments in which leg chassis interior 173 is substantially prismatic. Bottom surface 176 may be integral to leg receptacle 172 and disposed opposite leg chassis lid 174. At least one deployable table leg 178 may be hingedly attached interior to leg receptacle 172. In alternative embodiments, at least one deployable table leg may be removable affixable to leg receptacle 172 by other fastening means. In one embodiment, storage lid 114 may be integral to leg chassis 170. As illustrated, leg receptacle 172 may be stacked upon storage container 110. Leg chassis 170 may be hingedly mounted to storage receptacle 112 and alternatively to storage lid 114. Such a hinged mounting may enable one-hundred-and-eighty degrees of travel of leg chassis 170 relative to storage receptacle 112 and alternative storage-kid 114, such that bottom surface 176 of leg chassis 170 may be rotated to inverted position 10 adjacent to storage lid 114, such that bottom surface 176, in some embodiments, is coplanar with storage lid 114 in inverted position 10, enabling bottom surface 176 and storage lid 114 to be used in combination as a singular work surface as illustrated. In such an inverted position 10, at least one deployable table leg 178 may be deployed to provide additional structural support and stability to storage container 110 and leg chassis 170 when storage container 110 is resting upon caddy 120 (FIG. 1). In some embodiments, container and caddy system 100 may further include carriage 210. Carriage 210 may be structured and arranged to surround container 110 on at least two sides or two lateral sides and support a bottom of container 110. Preferably, carriage 210 is a sheet metal component having three leaves arranged perpendicularly to each other. In some embodiments, carriage 210 is a unitary sheet metal component. Carriage 210 may include at least one drawer track 212. Preferably, at least one drawer track 212 includes a pair of drawer tracks opposingly arranged. At least one drawer track 212 may be disposed exterior to carriage 210, such that carriage 210 may be mounted in a vehicle as a drawer, with at least one drawer track 212 enabling carriage 210 to slide out from the vehicle. Alternatively, at least one drawer track 212 may be disposed interior to carriage 210 as illustrated, such that container 110 may be slidably mounted to carriage 210. The functionality of at least one drawer track 212 may improve the ease of transitioning container 110 between a vehicle or other location and caddy 120 (FIG. 1).

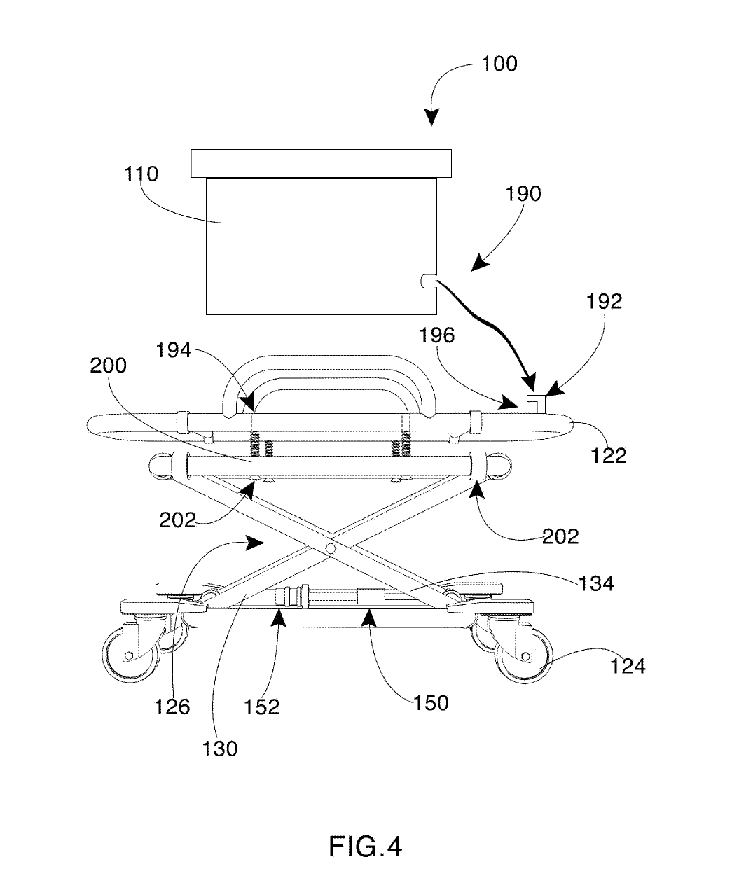

FIG. 4 is a side perspective view of container and caddy system 100 of FIG. 1, according to an embodiment of the present disclosure. In some embodiments, container and caddy system 100 may also include electric drive 150. Electric drive 150 can raise and lower container frame 122 relative to wheel 124. Container and caddy system 100 may also include rechargeable battery 152. Rechargeable battery 152 may be electrically coupled to electric drive 150 and may provide power to electric drive 150. Electric drive 150 may be mechanically coupled to one or more lift members 126 and may be configured to raise and lower container frame 122 relative to wheel 124 by scissoring first lift-member assembly 130 and second lift-member assembly 132. In alternative embodiments, container frame 122 may be raised or lowered by manual means. Storage container 110 may include recess 190, and container frame 122 may include hooked member 192. Hooked member 192 may be able to engage recess 190 of storage container 110, such that terminal end 196 of hooked member 192 is substantially parallel to container frame 122, thereby preventing storage container 110 from being lifted from container frame 122 when the terminal end 196 of hooked member 192 is inserted into recess 190 of storage container 110. Container frame 122 may yet also include at least one screw aperture 194 having internal threading structured to accept a machine screw in some embodiments. Container and caddy system 100 may further include at least one leveling member 200. At least one leveling member 200 may be interposed between container frame 122 and at least two lift members 126 and may have at least two captive screws 202. At least two captive screws 202 may be fastenable into at least one screw aperture 194 of container frame 122, such that turning at least two captive screws 202 adjusts a distance between at least one leveling member 200 and container frame 122. In such an embodiment, at least two lift members 126 may be fastened to at least one leveling member 200 rather than directly to container frame 122.

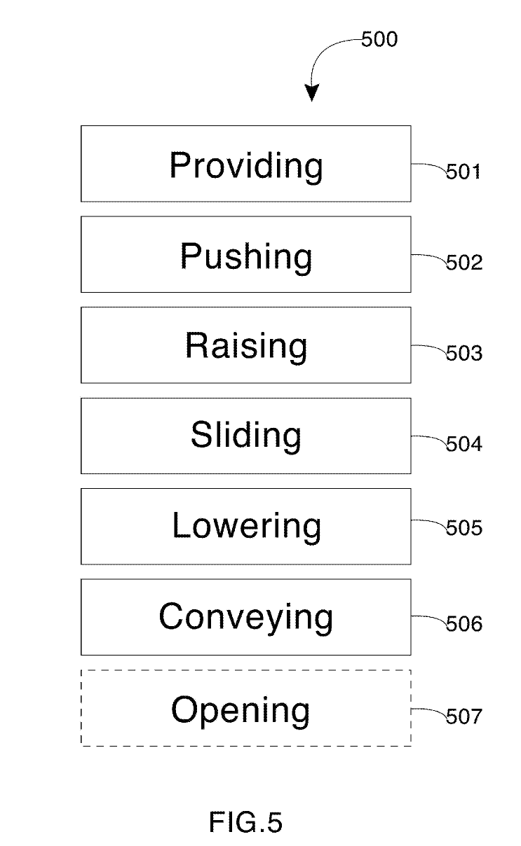

FIG. 5 is a flow diagram illustrating a method for using a container and caddy system, according to an embodiment of the present disclosure. In particular, the method for using a container and caddy system 500 may include one or more components or features of the container and caddy system 100 as described above. As illustrated, the method for using a container and caddy system 500 may include the steps of: step one 501, providing storage container and raisable caddy system comprising a storage container having a storage receptacle, a storage lid, at least one hinge pivotably connecting the storage lid to the storage receptacle, such that when the storage lid is in a closed condition, the storage lid and the storage receptacle in combination enclose an interior space; and a caddy having a container frame able to accept and support the storage container, four wheels, and at least two lift members, each of the at least two lift members corresponding to one or more of the four wheels, each of the at least two lift members mechanically connecting the corresponding ones of the four wheels to the container frame, the at least two lift members comprising a first lift-member assembly, a second lift-member assembly, and a pair of hinge pins coupling the first lift-member assembly to the second lift-member assembly, such that the first lift-member assembly and the second lift-member assembly are able to pivot relative to each other in a scissoring fashion; step two 502, pushing the caddy proximal to the storage container; step three 503, pushing the caddy proximal to the storage container; step four 504, raising and alternatively lowering the container frame until the container frame is substantially level with the storage container; step five 505, sliding the storage container onto the container frame; lowering and alternatively raising the container frame to a desired height for transport; step six 506, conveying the caddy to a desired location; and step seven 507, opening the container lid of the storage container to access contents interior to the storage container.

It should be noted that step 507 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for using a container and caddy system are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A container and caddy system comprising:
a storage container having
a storage receptacle,
a storage lid,
at least one hinge pivotably connecting the storage lid to the storage receptacle, such that when the storage lid is in a closed condition, the storage lid and the storage receptacle in combination enclose an interior space; and
a caddy having
a container frame able to accept and support the storage container,
three or four wheels, and
a lift member, corresponding to one or more of the wheels, connecting the corresponding wheels to the container frame, a lift member comprising
a first lift-member assembly,
a second lift-member assembly, and
a hinge pin coupling the first lift-member assembly to the second lift-member assembly, such that the first lift-member assembly and the second lift-member assembly are able to pivot relative to each other in a scissoring fashion.

2. The container and caddy system of claim 1, further comprising another hinge pin wherein the hinge pins centrally bisect each of the first lift-member assembly and the second lift-member assembly.

3. The container and caddy system of claim 1, further comprising at least one other wheel and a wheel frame mechanically connecting the wheels to each other, the wheel frame being substantially rectangular.

4. The container and caddy system of claim 3, wherein each of the first lift-member assembly and the second lift-member assembly are hingedly coupled to the wheel frame.

5. The container and caddy system of claim 1, wherein the container frame comprises at least one slide and each of the at least two lift members further comprise at least one yoke, wherein each of the at least one yokes are dimensioned to circumscribe and slide upon the at least one slide, thereby enabling the first lift-member assembly to pivot relative to the second lift-member assembly, such that when the first lift-member assembly and the second lift-member assembly together pivot, the container frame is either raised or lowered.

6. The container and caddy system of claim 1, further comprising an electric drive configured to raise and lower the container frame relative to the four wheels.

7. The container and caddy system of claim 6, further comprising a rechargeable battery electrically coupled to the electric drive.

8. The container and caddy system of claim 6, wherein the electric drive is mechanically coupled to one of the at least two lift members, the electric drive being configured to raise and lower the container frame relative to the four wheels by scissoring the first lift-member assembly and the second lift-member assembly.

9. The container and caddy system of claim 1, wherein the container frame comprises a rectangular chassis, a left guide rail, and a right guide rail, the rectangular chassis having a chassis length and a chassis width each sufficiently large to support the storage container, the left guide rail mirroring the right guide rail across the rectangular chassis, the left guide rail and the right guide rail each being affixed rigidly and perpendicularly to the rectangular chassis such that the left guide rail and the right guide rail each stand upright, the left guide rail and the right guide rail being spaced wide enough to surround the storage container on opposite sides of the storage container when the storage container is placed upon the rectangular chassis.

10. The container and caddy system of claim 1, wherein the storage container further comprises a leg chassis, the leg chassis being hingedly attached to the storage receptacle and alternatively to the storage lid, the leg chassis including
a leg receptacle defining a leg chassis interior;
a leg chassis lid hingedly attached to the leg receptacle;
a bottom surface integral to the leg receptacle and disposed opposite to the leg chassis lid; and
at least one deployable table leg hingedly attached interior to the leg receptacle.

11. The container and caddy system of claim 10, wherein the storage lid is integral to the leg chassis.

12. The container and caddy system of claim 10, wherein the leg chassis is hingedly mounted to the storage receptacle and alternatively to the storage lid enabling one-hundred-and-eighty degrees of travel, such that the bottom surface of the leg chassis may be rotated to an inverted position adjacent to the storage lid of the storage container, such that the bottom surface is coplanar with the storage lid, enabling the bottom surface and the storage lid to be used in combination as a singular work surface.

13. The container and caddy system of claim 1, wherein the storage lid and the storage receptacle in combination enclose a substantially prismatic interior space.

14. The container and caddy system of claim 1, wherein the storage container comprises a recess and the container frame comprises a hooked member configured to engage the recess of the storage container, such that a terminal end of the hooked member is substantially parallel to the container frame, thereby preventing the storage container from being lifted from the container frame when the terminal end of the hooked member is inserted into the recess of the storage container.

15. The container and caddy system of claim 1, wherein the container frame comprises at least one screw aperture having internal threading able to accept a machine screw.

16. The container and caddy system of claim 15, further comprising at least one leveling member interposed between the container frame and the at least two lift members, the at least one leveling member including at least two captive screws, the at least two captive screws being fastenable into the at least one screw aperture of the container frame, such that turning the at least two captive screws adjusts a distance between the at least one leveling member and the container frame.

17. A storage container and raisable caddy system comprising:
a storage container having
a storage receptacle,
a storage lid,
at least one hinge pivotably connecting the storage lid to the storage receptacle, such that when the storage lid is in a closed condition, the storage lid and the storage receptacle in combination enclose an interior space; and
a caddy having
a container frame able to accept and support the storage container,
four wheels, and
at least two lift members, each of the at least two lift members corresponding to one or more of the four wheels, each of the at least two lift members mechanically connecting the corresponding ones of the four wheels to the container frame, the at least two lift members comprising
a first lift-member assembly,
a second lift-member assembly, and
a pair of hinge pins coupling the first lift-member assembly to the second lift-member assembly, such that the first lift-member assembly and the second lift-member assembly are able to pivot relative to each other in a scissoring fashion;
wherein the pair of hinge pins centrally bisect each of the first lift-member assembly and the second lift-member assembly;
further comprising a wheel frame mechanically connecting the four wheels to each other, the wheel frame being substantially rectangular;
wherein each of the first lift-member assembly and the second lift-member assembly are hingedly coupled to the wheel frame;
wherein the container frame comprises at least one slide and each of the at least two lift members further comprise at least one yoke, wherein each of the at least one yoke are dimensioned to circumscribe and slide upon the at least one slide, thereby enabling the first lift-member assembly to pivot relative to the second lift-member assembly, such that when the first lift-member assembly and the second lift-member assembly together pivot, the container frame is either raised or lowered;
further comprising an electric drive able to raise and lower the container frame relative to the four wheels;
further comprising a rechargeable battery electrically coupled to the electric drive, such that the rechargeable battery may provide power to the electric drive;
wherein the electric drive is mechanically coupled to one of the at least two lift members, the electric drive being configured to raise and lower the container frame relative to the four wheels by scissoring the first lift-member assembly and the second lift-member assembly;
wherein the container frame comprises a rectangular chassis, a left guide rail, and a right guide rail, the rectangular chassis having a chassis length and a chassis width each sufficiently large to support the storage container, the left guide rail mirroring the right guide rail across the rectangular chassis, the left guide rail and the right guide rail each being affixed rigidly and perpendicularly to the rectangular chassis such that the left guide rail and the right guide rail each stand upright, the left guide rail and the right guide rail being spaced wide enough to surround the storage container on opposite sides of the storage container when the storage container is placed upon the rectangular chassis;
wherein the storage container further comprises a leg chassis, the leg chassis being hingedly attached to the storage receptacle of the container and alternatively to the storage lid of the storage container, the leg chassis including
a rectangular leg receptacle defining a leg chassis interior;
a leg chassis lid hingedly attached to the leg receptacle;
a bottom surface integral to the leg receptacle and disposed opposite to the leg chassis lid; and
at least one deployable table leg hingedly attached interior to the leg receptacle;
wherein the storage lid is integral to the leg chassis;
wherein the leg chassis is hingedly mounted to the storage receptacle of the storage container and alternatively to the storage lid of the storage container enabling one-hundred-and-eighty degrees of travel, such that the bottom surface of the leg chassis may be rotated to an inverted position adjacent to the storage lid of the storage container, such that the bottom surface is coplanar with the storage lid, enabling the bottom surface and the storage lid to be used in combination as a singular work surface;
wherein the storage lid and the storage receptacle in combination enclose a substantially prismatic interior space;
wherein the storage container comprises a recess and the container frame comprises a hooked member able to engage the recess of the storage container, such that a terminal end of the hooked member is substantially parallel to the container frame, thereby preventing the storage container from being lifted from the container frame when the terminal end of the hooked member is inserted into the recess of the storage container;
wherein the container frame comprises at least one screw aperture having internal threading able to accept a machine screw; and
further comprising at least one leveling member interposed between the container frame and the at least two lift members, the at least one leveling member including at least two captive screws, the at least two captive screws being fastenable into the at least one screw aperture of the container frame, such that turning the at least two captive screws adjusts a distance between the at least one leveling member and the container frame.

18. A method of using a container and caddy system, the method comprising the steps of:
providing storage container and raisable caddy system comprising a storage container having a storage receptacle, a storage lid, at least one hinge pivotably connecting the storage lid to the storage receptacle, such that when the storage lid is in a closed condition, the storage lid and the storage receptacle in combination enclose an interior space; and a caddy having a container frame able to accept and support the storage container, four wheels, and at least two lift members, each of the at least two lift members corresponding to one or more of the four wheels, each of the at least two lift members mechanically connecting the corresponding ones of the four wheels to the container frame, the at least two lift members comprising a first lift-member assembly, a second lift-member assembly, and a pair of hinge pins coupling the first lift-member assembly to the second lift-member assembly, such that the first lift-member assembly and the second lift-member assembly are able to pivot relative to each other in a scissoring fashion;
pushing the caddy proximal to the storage container;
raising and alternatively lowering the container frame until the container frame is substantially level with the storage container;
sliding the storage container onto the container frame;
lowering and alternatively raising the container frame to a desired height for transport; and
conveying the caddy to a desired location.

19. The method of claim 18, further comprising the steps of
opening the container lid of the storage container to access contents interior to the storage container.
